(19) United States
(12) Patent Application Publication
(10) Pub. No.: US 2015/0238924 A1
(43) Pub. Date: Aug. 27, 2015

(54) Modular, continuous, and scalable chemical reactor system which uses an auger / feed screw

(71) Applicant: Erick Keenan, Franlinville, NJ (US)

(72) Inventor: Erick Keenan, Franlinville, NJ (US)

(21) Appl. No.: 14/189,832

(22) Filed: Feb. 25, 2014

(51) Int. Cl. B01J 19/18

(52) U.S. Cl. CPC B01J 19/18; B01J 2219/00033

(57) ABSTRACT

This invention pertains to a “modular, continuous, auger/feed screw, and scalable, chemical reactor systems” which can be used to produce pharmaceutical compounds, petrochemical products, Bio chemicals, organic compounds, inorganic compounds, and life science products.

### CROSS-REFERENCE TO RELATED APPLICATIONS

### References Cited

### US PATENT DOCUMENTS:

| Number: | date: | author: |
|---|---|---|
| 4,311,803 | January 1982 | Smith et al. |
| 4,755,297 | Jul. 5, 1988 | Nerad, Bruce A. |
| 4,677,224 | June 1987 | Commeyras et al. |
| 6,022,419 | Feb. 8, 2000 | Torget; Robert W. |
| 6,268,531 | Jul. 31, 2001 | Hsu; Yung C. |

### Other References

### Provisional Patent:

| Number: | date: | author: |
|---|---|---|
| 61/887,673 | Oct. 7, 2013 | Keenan, Erick |

### STATEMENT REGARDING FEDERALLY SPONSORED RESEARCH OR DEVELOPMENT

Not Applicable

### BACKGROUND OF INVENTION

International Classification: A23K 1/16 (20060101); B01D 61/02 (20060101); B01D 013/00; B01J 14/00 (20060101); B01J 19/18 (20060101); B01J 19/24 (20060101); C07C 29/00 (20060101); C07C 29/76 (20060101); C07G 17/00 (20060101); C07G 17/00 (20130101); C08H 5/00 (20060101); C08H 04 (20060101); C13K 001/02; D21C 3/04 (20060101);

Current United States Classification: 023; 095; 55/16; 127/37; 127/1; 158;198; 202; 209; 210/321; 210/636; 210/637; 210/641; 321.65; 366; 422; 435/105; 502; 518; 562/580; 562/581; 641; 637;

1. Field of invention

The describe invention is envisioned in the use as a reactor for the production of products being inorganic and organic chemicals or biological chemicals for life sciences. The invention is a replacement for batch style reaction reactors and the segmented process they are used in by providing a single continuous, modular reactor system.

2. Discussion of related art

In general, current reaction equipment used in industry is of batch or semi batch design which has several short comings. They are not continuous which makes them an inefficient design, wasting time to load and run a relatively, specific small volume of reactants between batches with a required costly down time for a “reset-up” step. Waste and loss can be very financially significant as a single batch tank is subject to an entire volume of reactants expose to mishap and loss. Also the batch process, in many situations, cannot as a unit complete all of the required processing without removal of the semi-finished product which is a time waste, costly, potentially hazardous, can have loss of material and can degrade the product by exposure to the atmosphere. A modular, continuous, and scalable chemical reactor system which uses an auger/feed screw will overcome all of the aforementioned flaws.

### BRIEF SUMMARY OF THE INVENTION

This invention pertains to a modular, continuous, and scalable chemical reactor system using an auger/feed screw which can be used to produce pharmaceutical compounds, petrochemical products, biological chemicals, life science and bio-mass products. It has been designed to handle reactions that produce viscous slurry products during the chemical reaction process and/or reactions that process powders, liquid and gas reactants during a reaction. An advantage of a “continuous—one integrated device design” is that it does not require the reactor shut down and transfer of reactants from a batch reactor station to the next which is economically costly and an inefficient, labor intensive procedure. It is envisioned the “auger/feed screw” will convey solid and liquid reactants through a “tube body” allowing them to mix and chemically react to produce a product. During a controlled rotation the auger/feed screw meters volume intake, mixing and generates sheer to promote an efficient and controlled chemical reaction. The auger/feed screws can be designed so that the profiles are varied to specific requirements, such as mixing, volume control, sheer generation, compression, flow regulation and heat transfer.

At the start of the process the reactants are introduced into the reaction/mixing chamber from the liquid and powder feed ports located on the introducer module to initiate the reaction. As the annular space is filled, the reactants begin to be mixed, react and heated or cooled by the jacket as the rotation of the feed screw begins to convey the material through the process. While proceeding down the reactor, temperature monitoring and control is performed, mixing completeness is check and more ports positioned along this section can add reactants or solvents as required. A design advantage of the feed screw is when processing vicious slurry is it is only moving and handling a very small volume which with the requirement of low mechanical torque conveyance is done with no issues. Options such as ultrasonic mixing outside the reaction chamber tube and RF heating can be added in this section. After reaction completion the liquid is removed via a vacuum section that has several porous rings entrapped in a vacuum jacket, more drying can be with a heated jacketed further down the line. Also, if the product needs to be cooled down a cooling jacket can be added before the product exit tube. Other additions to condition the product can be gas inlets, ultrasonic generators to break up the powder and feed screw modifications to let the powder release. Inline QC inspection can be done anywhere along the tube and reject diverters can also set inline which can be computer controlled.

### BRIEF SUMMARY OF THE SEVERAL VIEWS OF THE DRAWINGS

FIG. 1 “An assembly drawing of a typical base model modular, continuous, scalable, chemical reactor systems” which uses an auger/feed screw.

FIG. 2 “Introducer module”

FIG. 3 “Introducer auger/feed Screw”

FIG. 4 “Reaction/mixing module”

FIG. 5 “Mixing and conveying auger/feed Screw”

FIG. 6 “Section view of mixing and conveying auger/feed screw”

FIG. 7 “Reflux and tee module”

FIG. 8 “Crystallization module”

FIG. 9 “Filtration module”

FIG. 10 “QC module”

FIG. 11 “Drying module”

FIG. 12 “Rejection and output module”

### DETAILED DESCRIPTION OF THE INVENTION

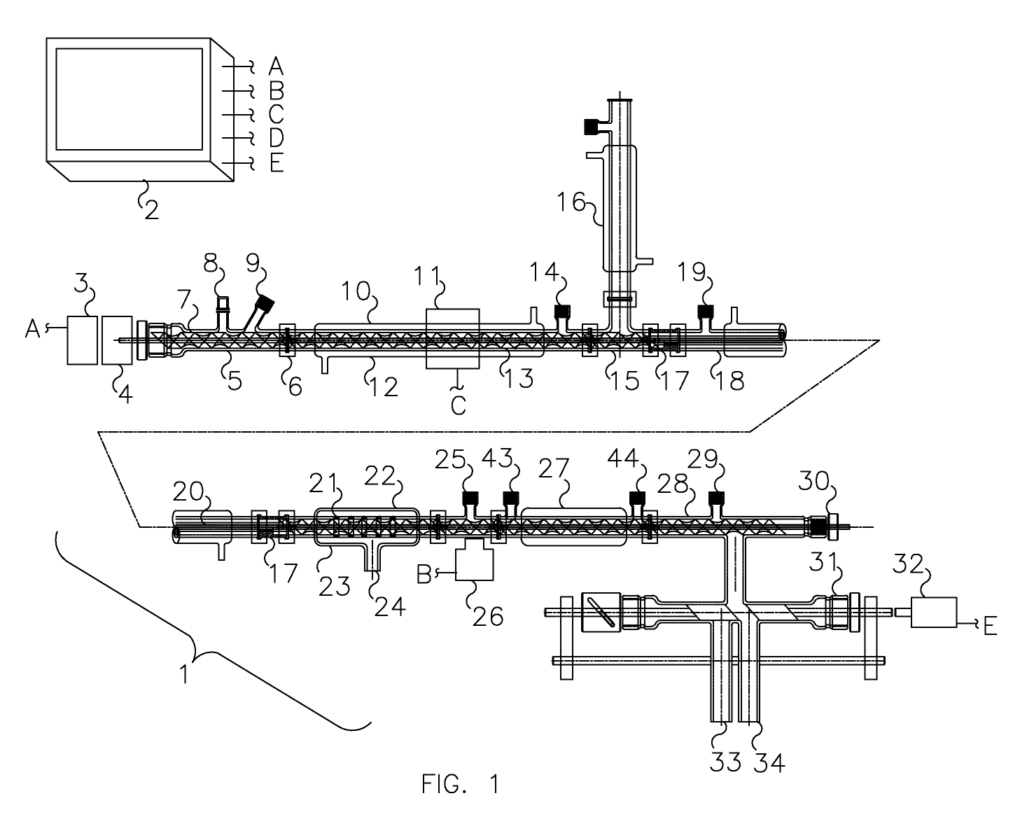

Shown in FIG. 1 is a typical complete assembly of a base model, continuous, scalable, chemical reactor system which uses an auger/feed screw 1 and a computer control system with software 2. As of most industrial control systems a typical array of inputs and outputs (“A”, “B”, “C”, “D”, “E”. . . ) are used to control, monitor, perform quality control and data logging. A reactor system can be produced in different capacity sizes from any materials suitable for the laboratory and industrial environments. Module order can be changed and the assembly shown is only one envisioned order in which the arrangement can be set. Processing starts with the introduction of reactants or materials into the Introducer module 5 via the In-feed port 9 and will end with the output of product from the accepted product output exit 34 or rejected product output exit port 33.

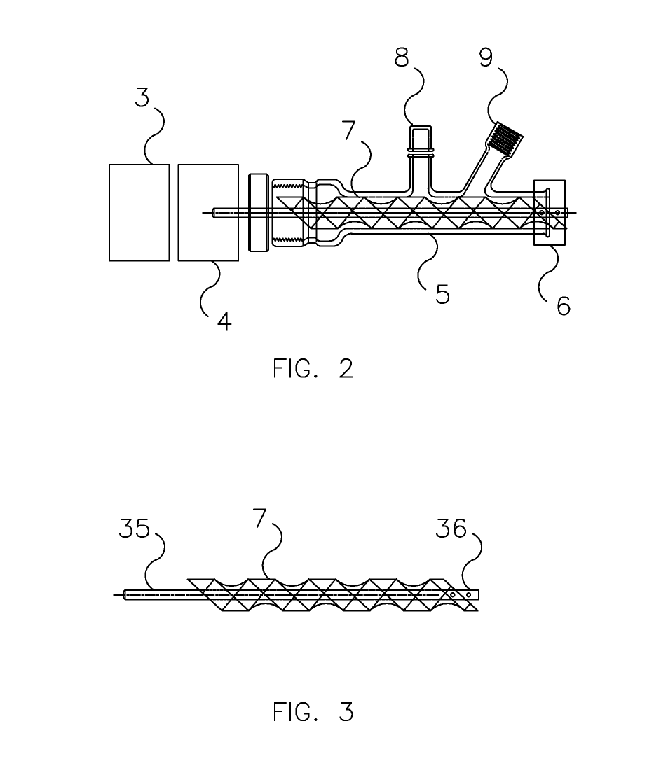

As the reactor system 1 comes online, the computer control system 2 turns on the drive motor 3 and engages the clutch 4 to begin rotation of the auger/feed screw 7 inside the introducer module 5. After the desired rpms are reached the addition of raw materials or reactants are introduced by way of the in-feed port 9 at the desired controlled rate. FIG. 2 shows a more detailed illustration of the relationship of the component pieces with in the introducer module 5 assembly. Units can have additional in-feed ports for a slight variation; one such style is shown in FIG. 2 with an in-feed port cap 8 above an in-feed port it to close it off when not in use. If more in-feed ports 9 are needed they can be added as required and may also have different docking requirements. A coupling clamp 6 which is fluid tight and can handle high pressures will join the adjacent modules to each other as shown in FIG. 1. System set up is quick and easy as detailed in FIG. 3, a simple snap lock pin 36 attaches each of the component auger/feed screws and this system of interlocking auger/feed screw sections are typical throughout the assembly. A drive spine 35 is a metal or polymer solid rod or hollow tube that is mechanical fixed into the auger/feed screw outer body by mechanical fit and physical adhesion.

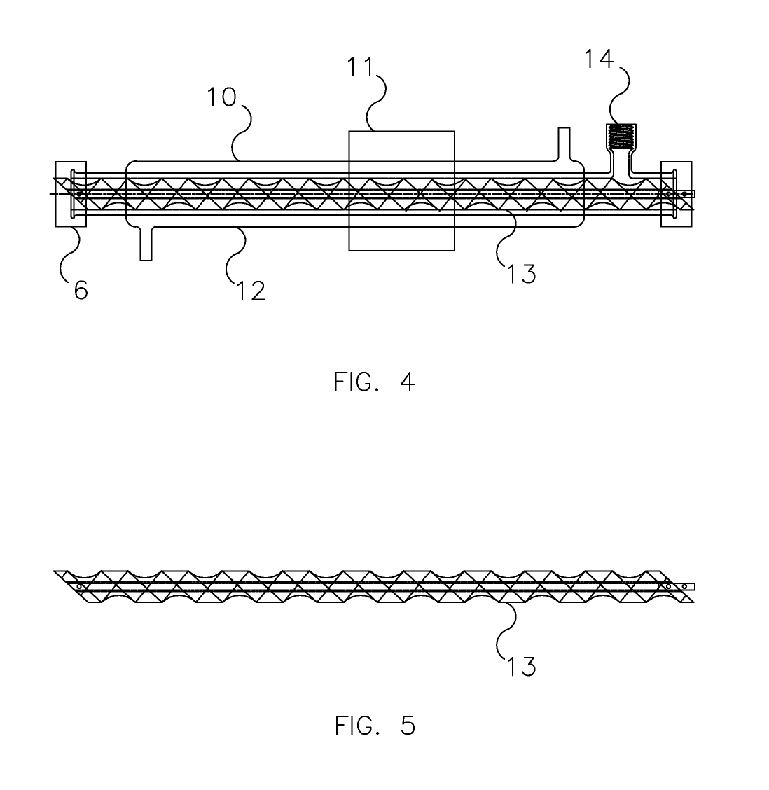

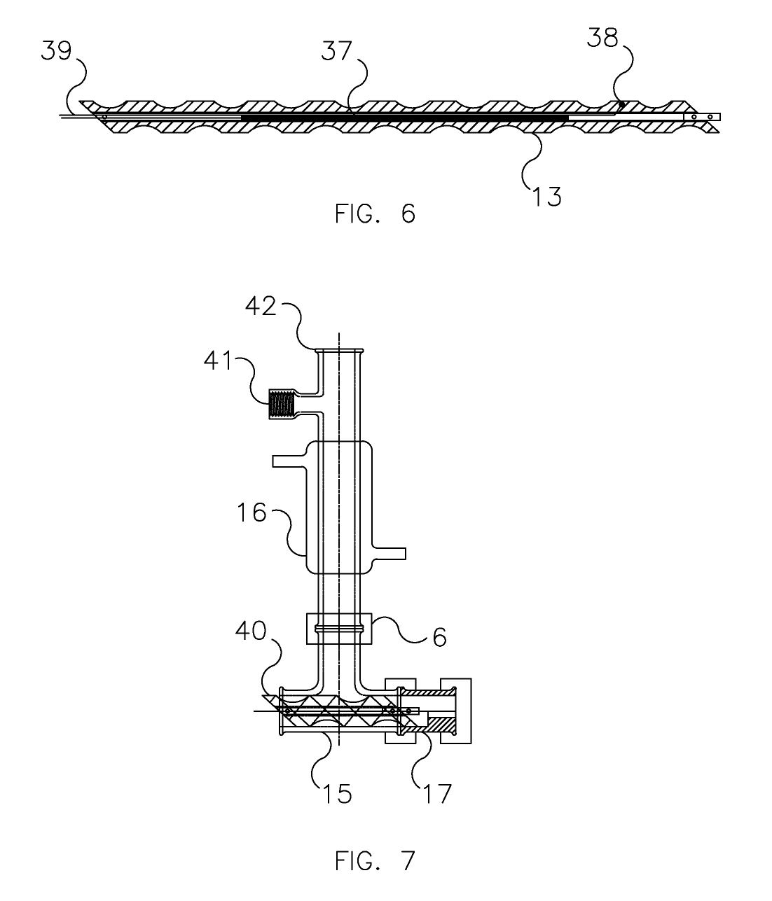

Reactant materials begin to be processed by mixing and heating/cooling in the reaction/mixing module 10 as illustrated in FIG. 4. Typical to the assembly is; a mixing/conveying auger/feed screw 13, a heating/cooling jacket 12, a temperature monitoring port 14, a ultrasonic/vibration mixer 11, and typical coupling clamp 6. A reaction/mixing module 10 can be of any length and internal diameter with multiples placed in series or parallel, also in a horizontal or vertical orientation if needed. A more detailed view is shown in FIG. 5 of a typical outside profile of the mixing/conveying, auger/feed screw 13, but the design can be of any varying profile needed to increase mixing, material handling and timing of material conveyance. The section view in FIG. 6 shows some internal enhancements that can be applied to the mixing/conveying, auger/feed screw 13, such as an electrical heating cartridge 37 and an embedded thermocouple 38 with the electrical lead wires 39 hooked back to the power and control system.

During the reaction some generation of heat will cause the evaporation of solvent and to prevent the escape a distillation reflux module 16 is placed inline on top of a tee module 15. In FIG. 7 is shown the typical configuration of this use with the auger/feed screw 40, a temperature monitoring or vacuum port 41, and a beaded end for coupling 42 to allow the addition of more modules or a cap. A weir flow control module 17 is an option that can be put next in the process order to hold back some of the material at a controlled rate, this is shown in section view and without the drive spine in place for clarity.

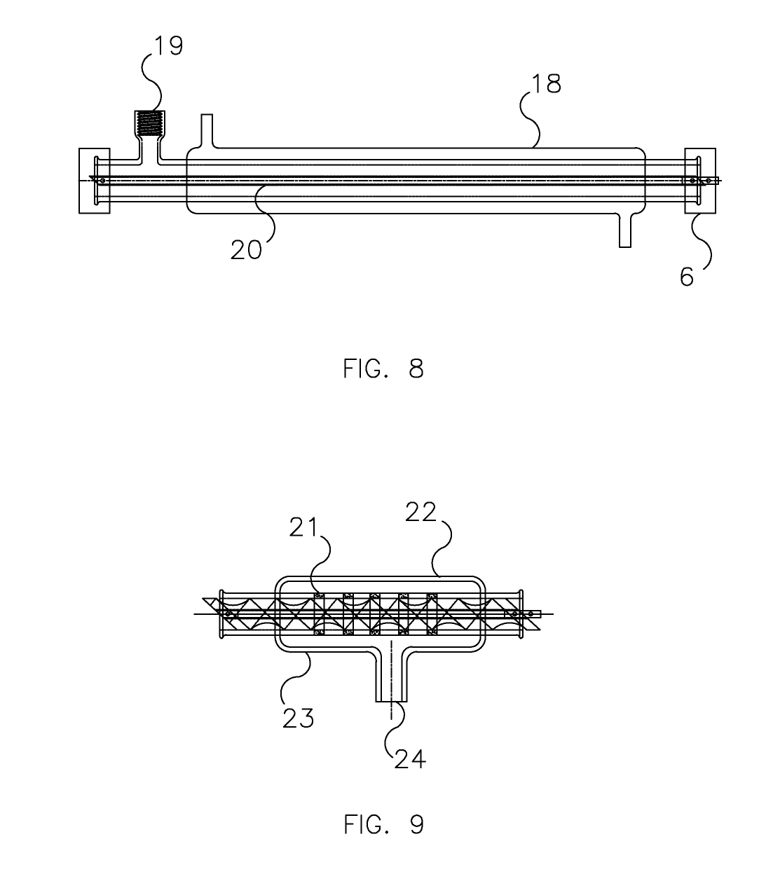

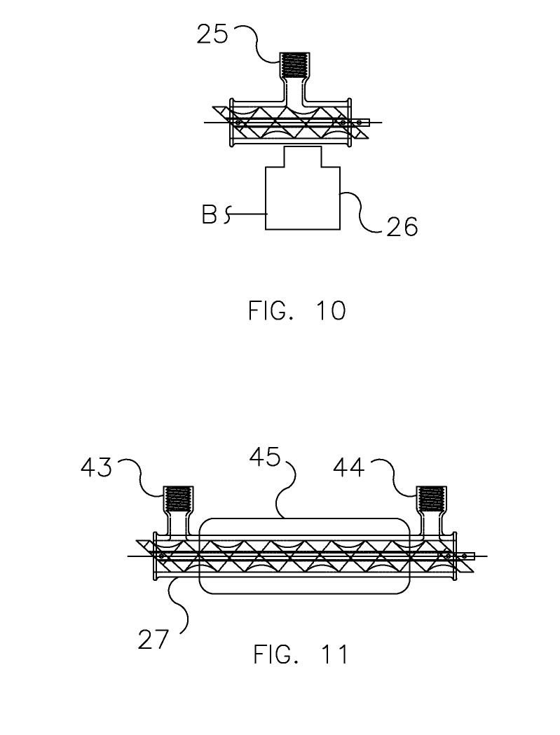

After the reaction is completed in this example, but not in all applications, the material is fed in to a crystallization module 18 where the introduction of a solvent is injection in through the crashing solvent fluid port 19 to promote crystallization. In this module, as shown in FIG. 8, a different auger/feed screw is use and it is has a profile that is just a cylinder with no screw flutes and therefore it is just an idler screw 20 only used to transmit power through to the next module. Some variations can be used such as screws with small pin mixers, depending on the needs. Product, a slurry mix, is pushed into the vacuum filter module 23, which has an alternating sintered filter section 21 and plain solid tube section wrapped by a vacuum jacket 22 (see FIG. 9). With a vacuum source hooked to the liquid exit 24 port the solvent can be pulled out of the product and captured into a waste tank.

A significant advantage of a continuous, scalable, chemical reactor system which uses an auger/feed screw system is the easy insertion of a QC/QC inspection device in any placement as it is needed. FIG. 10 is of a typical basic QC/QA sampling tee module with sample port 25; the port will let a probe to take internal readings and a generic QC/QA instrument 26 is for measurement of set parameters outside the tube body. Both will send data to the computer via line “B” for control input and data logging.

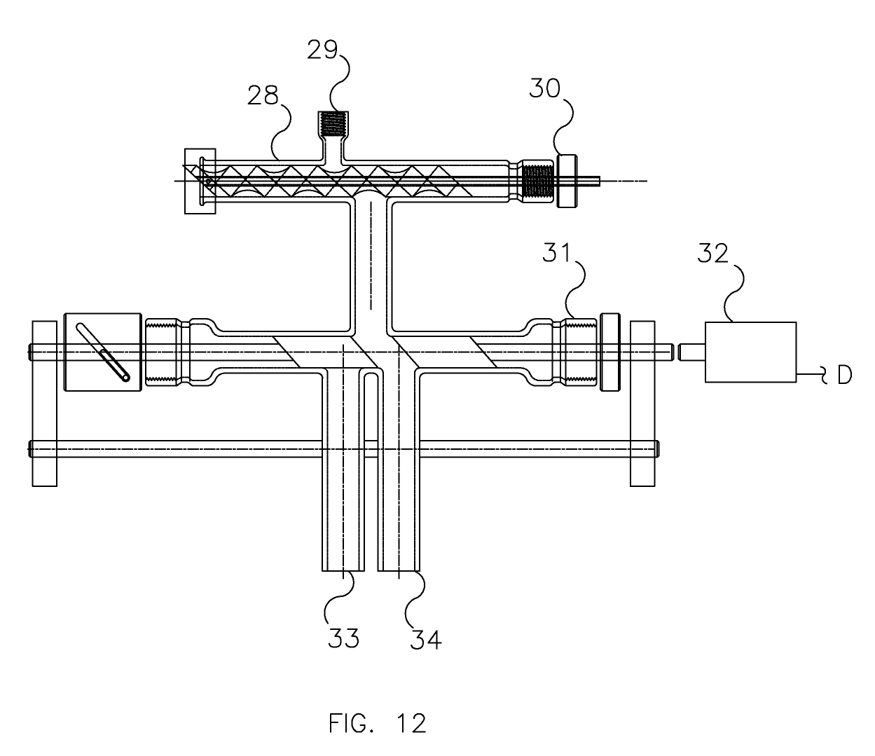

FIG. 11 is of a final drying module 27 with an auger/feed screw with ports on both ends. Drying gas in-feed port 43 pushes in clean, warn dry gas to remove moisture and the moist gas is removed out the drying gas vacuum removal port 44 to a condensation tank for safe storage. Heating to accelerate drying is achieved by the use of an electric heating jacket 45 which can be of the specified watts and controlled by a control system or manually set.

The final step in this example process is performed in the rejection and output module 28 as illustrated in FIG. 12. A wiper port 29 is in place to help break up the material and allow separation from the augur/feed screw which is support at its end by an end bearing cap 30. End product is transferred into the selector gate section 31 and computer signals the selector gate actuator 32 to sift the gate which determines to which port product is sent. “Good” or “bad” products can be selectively in process being sent to the accepted product output exit 34 or to the rejected product output exit 33 for packaging. Thus ends the complete process example using this reactor system.

1. What is claimed is a modular reactor assembly, where component parts are added and subtracted to perform as a complete “start to finish” unit.
a. This is also implied a scalability for more or less functions as the requirements demand.

2. A continuous feature is also claimed, where there is no need to remove the reactants from the reactor to perform assay on the reactants but, from introduction into the reactor to a completed product all processes are completed sequentially until the final product exits.

3. Claimed is the use of a feed screw or auger to convey, mix, heat, cool and meter the reactants throughout the reactor.
a. The use of an internal heating and cooling method for the “Feed Screw” or “Auger” is also claimed to be of benefit in this application.

4. Claimed is that liquids, solids and gasses can be utilized in the production of product with this reactor system.

5. A computer with process control software is claimed to be utilized in the control of the drive motor, material flow, quality control, data logging, quality assurance, pneumatic valve operation, heating, cooling, mixing, and any future requirements pertaining to such need in this design.

6. Claimed is the in line vacuum filter module invention for this reactor system.

7. Claimed is the in line weir flow control module invention for this reactor system.

8. Claimed is a snap and lock together drive line used in this reactor system.

9. Claimed is the small loss advantage due to small volume reactant chambers and in line control of small adjoined, segmented chambers and if needed the rejection of a proportionally small fraction from the entire run.
